(19) United States
(12) Patent Application Publication
(10) Pub. No.: US 2007/0042773 A1
(43) Pub. Date: Feb. 22, 2007

(54) Broadband wireless communication system for in-flight aircraft

(76) Inventor: Donald L. Alcorn, (US)

Correspondence Address: BRADLEY ARANT ROSE & WHITE LLP, 200 CLINTON AVE. WEST, SUITE 900, HUNTSVILLE, AL, 35801, US

(21) Appl. No.: 11/206,695

(22) Filed: Aug. 18, 2005

(51) Int. Cl. H04Q 7/20

(52) U.S. Cl. 455/431

(57) ABSTRACT

A broadband wireless communication system for in-flight aircraft has been developed. The system includes multiple ground transmission stations that are located along a predefined air corridor within overlapping communications range and a receiver station located on board the in-flight aircraft. The ground transmission stations provide a broadband wireless communications link according to IEEE 802.16 Air Interface Standard also called “WiMax”.

### BACKGROUND OF INVENTION

1. Field of the Invention

The invention relates generally to wireless telecommunications. More specifically, the present invention relates to a broadband wireless communication system for in-flight aircraft.

2. Background Art

High speed data communications is becoming more and more desirable and important to society. Most high speed data connections are available through telephone lines, cable modems or other such devices that have a physical wired connection. Since such a wired connection has limited mobility, wireless techniques for data communications are very attractive for airline passengers. However, high speed wireless data links have a range which in not practical for in-flight use. Alternatively, high speed links are available from satellites for in-flight aircraft. This option is costly since it requires a satellite link as well as specialized antennae and other equipment for the aircraft. Consequently, there is a need for a system that provides high speed data communications link to an in-flight aircraft at a reasonable cost.

### SUMMARY OF INVENTION

In some aspects, the invention relates to a system of providing high speed data communications to an in-flight aircraft, comprising: a plurality of ground transmission stations that are located along a predefined air corridor within overlapping communications range; and a receiver station located on board the in-flight aircraft, where the plurality ground transmission stations provide a high speed data communications link with the receiver station according to IEEE 802.16 Air Interface Standard.

In other aspects, the invention relates to a system of providing high speed data communications to an in-flight aircraft, comprising: a plurality of ground transmission stations that are located along a predefined air corridor within overlapping communications range; and a receiver station operated by an individual passenger on board the in-flight aircraft, where the plurality ground transmission stations provide internet access to the passenger according to IEEE 802.16 Air Interface Standard at a frequency between 10 GHz and 66 GHz.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a schematic view of a broadband communication system for in-flight aircraft in accordance with one embodiment of the present invention.

FIG. 2 shows an example of a broadband communication system for the continental United States in accordance with one embodiment of the present invention.

### DETAILED DESCRIPTION

The present invention is a system of providing high speed data communications for in-flight airliners utilizing a series of ground based transmitters along established common flight paths for multiple aircraft called “air corridors” that provides an IEEE 802.16 Air Interface Standard or “WiMax” connection. The ground transmitters are located in a pattern to provide overlapping coverage as an aircraft passes from one transmitter to the other. This allows passengers on the aircraft to have uninterrupted high speed data communications while in the air.

The IEEE 802.16 Air Interface Standard, often called “WiMax”, is a specification for fixed broadband wireless access systems employing a point-to-multipoint (PMP) architecture. The IEEE 802.16 Air Interface Specification is a very capable, while complex, specification with current data transfer rates of up to 75 megabits per second (Mbps). There are allowances for a number of physical layers for different frequency bands and region-by-region frequency regulatory rules. There are features that allow an IP centric system or an ATM centric system depending upon the needs of customers. The specification is designed to cover application to diverse markets from very high bandwidth businesses to SOHO and residential users. The initial version was developed with the goal of meeting the requirements of a vast array of deployment scenarios for broadband wireless access (BWA) systems operating between 10 and 66 GHz. Revisions to the base IEEE 802.16 standard targeting the sub 11 GHz are in envisioned and intended to be captured for use within the scope of the present invention.

System Profiles, Protocol Implementation Conformance Statement Proforma, Test Suite Structure & Test Purposes, and Abstract Test Suite specifications for 10 to 66 GHz and sub 11 GHz, have been developed all according to the ISO/IEC 9464 series (equivalent to ITU-T x.290 series) of conformance testing standards. The 802.16 standard covers both the Media Access Control (MAC) and the physical (PHY) layers access standard for systems in the frequency ranges 10-66 GHz and sub 11 GHz.

A number of PHY considerations were taken into account for the target environment. At higher frequencies, line-of-sight is a must. This requirement eases the effect of multi-path, allowing for wide channels, typically greater than 10 MHz in bandwidth. This gives IEEE 802.16 the ability to provide very high capacity links on both the uplink and the downlink. For sub 11 GHz non line-of-sight capability is a requirement. The standard is designed to accommodate either Time Division Duplexing (TDD) or Frequency Division Duplexing (FDD) deployments, allowing for both full and half-duplex terminals in the FDD case.

The MAC is designed specifically for the PMP wireless access environment. It supports higher layer or transport protocols such as ATM, Ethernet or Internet Protocol (IP), and is designed to easily accommodate future protocols that have not yet been developed. The MAC is designed for very high bit rates of the truly broadband physical layer, while delivering ATM compatible Quality of Service (QoS); UGS, rtPS, nrtPS, and Best Effort.

The frame structure allows terminals to be dynamically assigned uplink and downlink burst profiles according to their link conditions. This allows a trade-off between capacity and robustness in real-time, and provides roughly a two times increase in capacity on average when compared to non-adaptive systems, while maintaining appropriate link availability.

The 802.16 MAC uses a variable length Protocol Data Unit (PDU) along with a number of other concepts that greatly increase the efficiency of the standard. Multiple MAC PDUs may be linked into a single burst to save PHY overhead. Additionally, multiple Service Data Units (SDU) for the same service may be linked into a single MAC PDU, saving on MAC header overhead. Fragmentation allows very large SDUs to be sent across frame boundaries to guarantee the QoS of competing services. And, payload header suppression can be used to reduce the overhead caused by the redundant portions of SDU headers.

The MAC uses a self-correcting bandwidth request/grant scheme that eliminates the overhead and delay of acknowledgements, while simultaneously allowing better QoS handling than traditional acknowledged schemes. Terminals have a variety of options available to them for requesting bandwidth depending upon the QoS and traffic parameters of their services. They can be polled individually or in groups. They can steal bandwidth already allocated to make requests for more. They can signal the need to be polled, and they can piggyback requests for bandwidth.

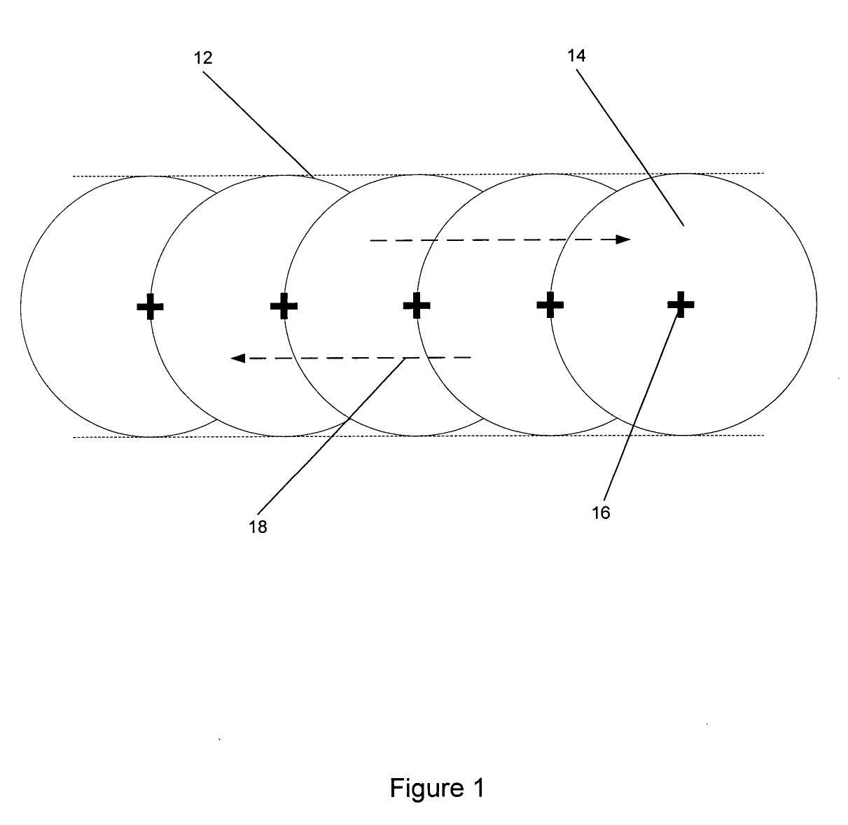

FIG. 1 shows an example of a broadband communication system 10 for in-flight aircraft in accordance with one embodiment of the present invention. The system 10 includes a series of ground located transmitters 16 located along an air corridor 12. As an airliner passes along its flight path 18, it moves along different coverage areas 14 provided by the transmitters 16 without a loss of communications. It should be understood that a single transmitter 16 may cover all aircraft within range in the air corridor 12. Also, an aircraft may be simultaneously within the overlapping range of multiple transmitters 16 as it travels along its flight path 18.

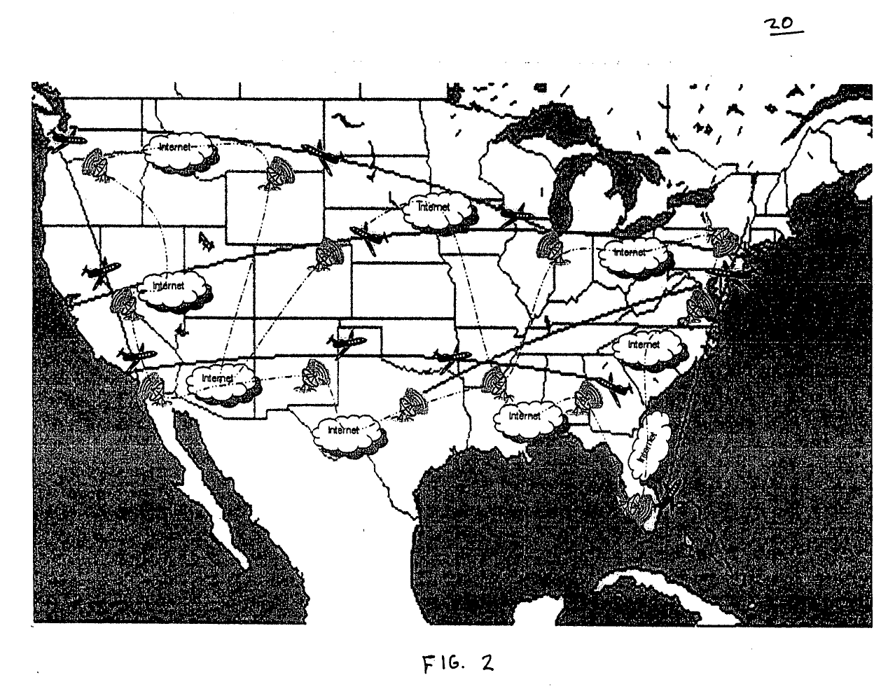

FIG. 2 shows an example of a WiMax broadband communication system 20 for the continental United States. It should be noted that the drawing is not to scale and the actual number of transmitters will be greater than shown. Transmission of WiMax signals typically requires a line-of-sight (LOS) link between the transmitter and receiver. While conventional WiMax performance standards typical have a maximum range of 34 miles, it is important to note that this range is from ground point to ground point. WiMax has a range of well over 100 miles for a ground point to aircraft link due to the increased distance of a LOS link.

A great majority of passenger aircraft in the United States travel in “air corridors” that function similar to highways. Air corridors typically exist along major east/west and north/south routes between high population areas (e.g., California, the northeastern corridor of the United States, etc.). Aircraft are routed along these corridors in order to more efficiently mover air traffic to and from their final destinations. Since most air traffic passes through these paths, a system for providing WiMax access to in-flight aircraft could cover only the air corridors in lieu of trying to coverage all airspace in the country. This has the advantage of providing a significant cost advantage by reducing the number of transmitters while still covering the majority of flights.

The system provides high speed broadband communications to an in-flight aircraft while the aircraft is within the air corridor. Technology to manage the user's transition from one transmitter to another is well known to those of ordinary skill in the art. The communications link may provide the user with such data communications as internet access, streaming video, voice-over IP, etc. Additionally, the system may provide data on the aircraft to parties on the ground such as an air traffic controller. Examples of aircraft data include air traffic control information, aircraft status and performance information, video security surveillance of the aircraft interior, etc. The system may be accessed directly by an individual aboard an aircraft. In an alternative embodiment, the system may be accessed by the aircraft that it turn provides individual access via an onboard network such as a LAN.

It is intended that embodiments of the present invention include present a future versions of IEEE 802.16 Air Interface Standard that are consistent with the present disclosure. While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A system of providing high speed data communications to an in-flight aircraft, comprising:
a plurality of ground transmission stations that are located along a predefined air corridor within overlapping communications range; and
a receiver station located on board the in-flight aircraft, where the plurality of ground transmission stations provide a high speed data communications link with the receiver station according to IEEE 802.16 Air Interface Standard.

2. The system of claim 1, where the receiver station is operated by an end user.

3. The system of claim 1, where the receiver station is operated by the aircraft.

4. The system of claim 3, where the aircraft provides an end user with access to the high speed data communications link through a network within the aircraft.

5. The system of claim 4, where the network is an LAN.

6. The system of claim 1, where the high speed data communications link comprises internet access.

7. The system of claim 1, where the high speed data communications link comprises streaming video access.

8. The system of claim 1, where the high speed data communications link comprises voice-over IP access.

9. The system of claim 1, where the high speed data communications link comprises access to data about the aircraft.

10. The system of claim 1, where the IEEE 802.16 Air Interface Standard operates at a frequency between 10 GHz and 66 GHz.

11. The system of claim 1, where the IEEE 802.16 Air Interface Standard operates at a frequency below 11 GHz.

12. The system of claim 1, where the high speed data communications link transfers data at a rate up to 75 Mbps.

13. A system of providing high speed data communications to an in-flight aircraft, comprising:
a plurality of ground transmission stations that are located along a predefined air corridor within overlapping communications range; and
a receiver station operated by an individual passenger on board the in-flight aircraft, where the plurality of ground transmission stations provide internet access to the passenger according to IEEE 802.16 Air Interface Standard at a frequency between 10 GHz and 66 GHz.

14. A method for providing high speed data communications to an in-flight aircraft, comprising:
providing a plurality of ground transmission stations that are located along a predefined air corridor within overlapping communications range; and
linking the plurality of ground transmission stations to a receiver station on board an in-flight aircraft to provide a high speed data communications link according to IEEE 802.16 Air Interface Standard.

15. The method of claim 14, where the receiver station is operated by an individual user on board the in-flight aircraft.

16. The method of claim 14, where the receiver station is operated by the aircraft.

17. The method of claim 16, where the aircraft provides an end user with access to the high speed data communications link through a network within the aircraft.
